(19) United States
(12) Patent Application Publication
(10) Pub. No.: US 2026/0070251 A1
(43) Pub. Date: Mar. 12, 2026

(54) MEDIUM PROCESSING APPARATUS

(71) Applicant: CASIO COMPUTER CO., LTD., Tokyo (JP)

(72) Inventor: Masakazu SUZUKI, Tokyo (JP)

(73) Assignee: CASIO COMPUTER CO., LTD., Tokyo (JP)

(21) Appl. No.: 19/284,976

(22) Filed: Jul. 30, 2025

(30) Foreign Application Priority Data
Sep. 6, 2024 (JP) 2024-153597

(51) Int. Cl. B26D 5/08; B26D 1/02

(52) U.S. Cl. CPC B26D 5/08; B26D 1/025

(57) ABSTRACT

A medium processing apparatus includes: a carriage including a processing section that processes a processed medium and a pressed section; and a pressing mechanism including an elastic body and a pressing section, wherein, the pressing mechanism is configured to be capable of adjusting a processing section pressing load at which the processing section of the carriage presses the processed medium by varying a pressing section pressing load at which the pressing section presses the pressed section toward the processed medium side based on an elastic load by the elastic body. A buffer is provided between the carriage and the pressing mechanism, wherein the buffer suppresses the pressing section pressing load until the processing section pressing load exceeds a predetermined load.

### CROSS-REFERENCE TO RELATED APPLICATIONS

This application is based upon and claims the benefit of priority under 35 USC 119 of Japanese Patent Application No.2024-153597, filed on September 6, 2024, entire disclosure of which, including the description, claims, drawings, and abstract, is incorporated herein by reference in its entirety.

### Background of the Invention

### Field of the Invention

This disclosure relates to a medium processing apparatus.

### Description of the Related Art

Conventionally, as a processing apparatus, a cutting apparatus is known. For example, such cutting apparatus cuts a medium to be cut as a cut target into a shape based on cut data such as an image. In such cutting apparatus, when cutting is performed, a blade presses a member against the medium to be cut and a cut is made in a longitudinal direction in a plane of the medium to be cut. For example, JP 2016-055380A describes an apparatus equipped with a changing member that can change a pressing force of the blade during the cutting operation of the medium to be cut, and there is a difference in the pressing force between an initial cutting operation from a start of cutting the medium to be cut to the cutting of a predetermined amount of the medium, and subsequent cutting operations.

However, it is a burden and it is complicated for the user to adjust pressing force of a processing section by changing the structure and changing the setting of the control parameters according to the processing conditions.

According to the present disclosure, a medium processing apparatus is provided that can appropriately control a pressing load that presses the processing section against the medium to be processed by a simple configuration.

### Summary

In order to solve the aforementioned problems, the medium processing apparatus of the present disclosure, includes, a carriage including a processing section that processes a processed medium and a pressed section; and a pressing mechanism including an elastic body and a pressing section, wherein, the pressing mechanism is configured to be capable of adjusting a processing section pressing load at which the processing section of the carriage presses the processed medium by varying a pressing section pressing load at which the pressing section presses the pressed section toward the processed medium side based on an elastic load by the elastic body, wherein a buffer is provided between the carriage and the pressing mechanism, wherein the buffer suppresses the pressing section pressing load until the processing section pressing load exceeds a predetermined load.

### Brief Description of the Drawing

FIG. 1 is a perspective view showing a configuration of a main part of a cutting apparatus, which is a processing apparatus according to the present embodiment.

FIG. 2 is a main part perspective view showing a configuration of the main part of a pressing mechanism and a carriage.

FIG. 3 is a main part perspective view showing a configuration of the main part of the pressing mechanism.

FIG. 4 is a plan view showing a configuration of the main part of the carriage according to the first embodiment, and a diagram showing a state of the blade in a "non-cutting position" and in a "contact position".

FIG. 5 is a descriptive diagram showing an own-weight range of the carriage in FIG. 4.

FIG. 6 is a plan view showing a configuration of the main part of the carriage according to the first embodiment, and a diagram showing a state of the blade in a "non-cutting position" and in a "separated position".

FIG. 7 is an enlarged view around a clearance α in FIG. 4.

FIG. 8 is a diagram showing the clearance α shown in FIG. 7 in a zero state.

FIG. 9 is a graph showing a change in how a pressing load is applied.

FIG. 10 is a graph showing the change in how the pressing load is applied in a case in which a weak spring is used as an elastic body of the pressing mechanism.

FIG. 11 is a graph showing the change in how the pressing load is applied in a case in which a strong spring is used as an elastic body of the pressing mechanism.

FIG. 12 is a plan view showing a configuration of the main part of the carriage according to the second embodiment, and a diagram showing a state of the blade in a "non-cutting position" and in a "contact position".

FIG. 13 is a plan view showing a configuration of the main part of the carriage according to the second embodiment, and a diagram showing a state of the blade in a "cutting position".

FIG. 14 is a plan view showing a configuration of the main part of the carriage according to the second embodiment, and a diagram showing a state of the blade in the "non-cutting position" and in a "separated position".

### DETAILED DESCRIPTION OF THE PREFERRED EMBODIMENTS

### <First Embodiment>

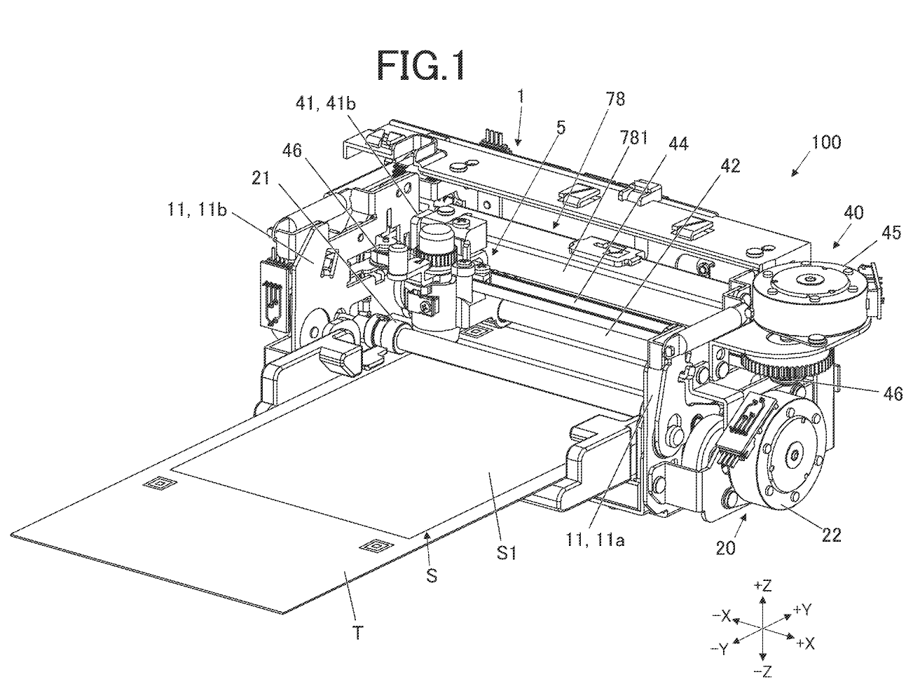

With reference to FIG. 1 to FIG. 11, a first embodiment of a processing apparatus according to the present disclosure is described. According to the present embodiment, the processing apparatus is a cutting apparatus 100 provided with a cutting section, which is a processing section that processes (cuts) a cut medium S, which is the medium to be cut, that is, the medium to be processed. An X-axis direction, a Y-axis direction, and a Z-axis direction shown in each diagram are perpendicular to each other. With the cutting apparatus 100 according to the present embodiment placed on a horizontal mounting surface, the X-axis and Y-axis directions are horizontal directions, and the Z-axis direction is an up-down direction (height direction of the cutting apparatus 100). According to the present embodiment, the X-axis and Y-axis directions are conceptualized to each include both positive and negative (+ and -) directions. Regarding the up-down direction, a +Z direction shall be an up direction and a -Z direction shall be a down direction. A +X direction, a -X direction, a +Y direction, a -Y direction, the +Z direction, and the -Z direction shall be the directions as shown in each drawing.

In the cutting apparatus 100, the cutting section and the cut medium S are moved relative to each other in the X-axis direction by a carriage moving mechanism 40 and in the Y-axis direction by a medium conveyance mechanism 20, and a height position of a blade 61 of the cutting section (cutter unit 6 described below) from a sheet surface S1 of the cut medium S (distance to the sheet surface S1 in a Z direction) is changed by a pressing mechanism 70. By coordinately controlling the relative movement in the X and Y directions toward the cut medium S by the carriage moving mechanism 40 and the medium conveyance mechanism 20 and a raising and lowering operation of the blade 61 by the pressing mechanism 70, the blade 61 of the cutting section is pressed against the sheet surface S1, which is the upper surface of the cut medium S (medium) in a sheet form as appropriate, and the cut medium S is cut into a desired shape. In the following embodiment, the following example is described, a carriage 5 carrying the cutter unit 6, which is the cutting section, moves in the X-axis direction, and the cut medium S is conveyed in the Y-axis direction. According to the present embodiment, the cut medium S is supplied to the cutting apparatus 100 overlapped on a backing paper T, as shown in FIG. 1. Even if the backing paper T is not mentioned in the following description, it is assumed that the cut medium S is transported and cut in a state overlapping the backing paper T.

The cutting apparatus 100 includes an apparatus main body 1 with various components assembled on sheet metal. The apparatus main body 1 may be provided inside a housing not shown. The apparatus main body 1 includes a pair of side plates 11 positioned with a space in the X-axis direction (side plate 11a positioned in the +X direction and side plate 11b positioned in the -X direction). A pair of conveyance rollers 21, 21 extending in the X-axis direction are supported between the pair of side plates 11a and 11b, overlapping in the Z-axis direction. In FIG. 1, the conveyance roller located on the lower side in the Z-axis direction (-Z direction in FIG. 1) of the pair of conveyance rollers 21, 21 is omitted from the drawing. One of the pair of conveyance rollers 21, 21 is a drive roller driven by a conveyance drive motor 22, and the other is a driven roller that rotates with the rotation of the drive roller. The cut medium S is conveyed along the Y-axis direction by being held between the pair of conveyance rollers 21, 21. The drive roller can rotate in either a forward or reverse direction by controlling the conveyance drive motor 22, and by switching the direction of the rotation of the drive roller, the transport direction of the cut medium S in the Y-axis direction can be switched in the +Y or -Y direction as needed. According to the present embodiment, the medium conveyance mechanism 20 (see FIG. 1) includes at least the pair of conveyance rollers 21, 21 and the conveyance drive motor 22 that drives the rollers. The medium conveyance mechanism 20 is configured to convey the cut medium S along the Y-axis direction.

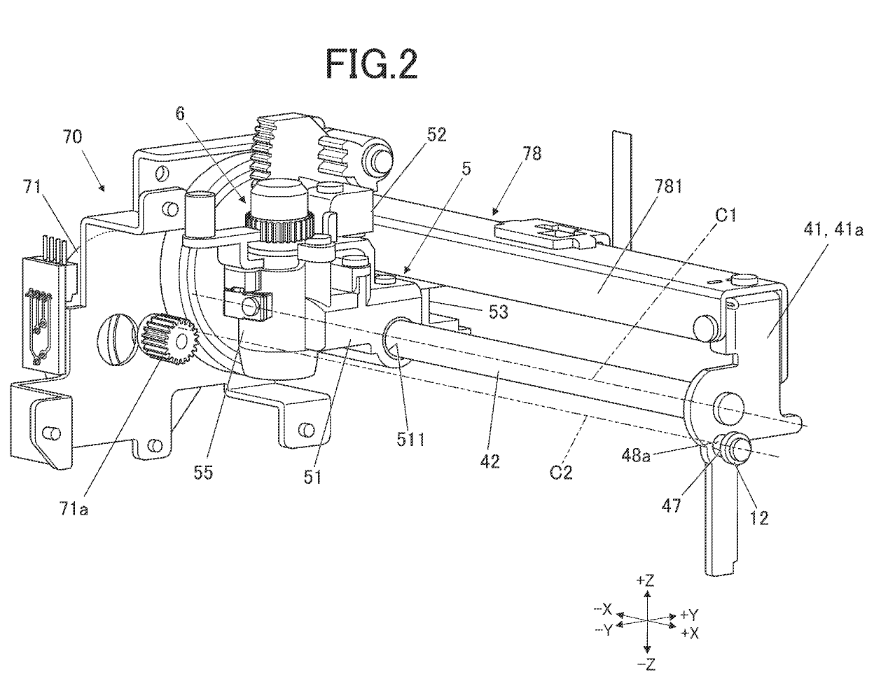

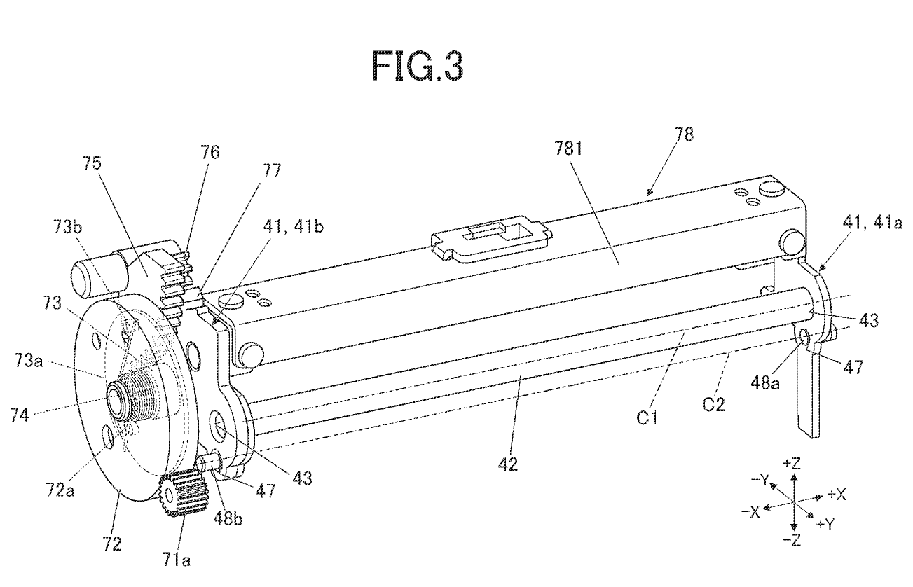

The cutting apparatus 100 also includes the carriage moving mechanism 40 (see FIG. 1) that moves the carriage 5 including the cutter unit 6, which is the cutting section, along the X-axis direction. The carriage moving mechanism 40 includes a pair of support plates 41 that are positioned on the inner side of the pair of side plates 11a and 11b of the apparatus main body 1 in the X-axis direction, approximately parallel to the side plates 11a and 11b, respectively. In the examples shown in FIG. 1 to FIG. 3, a support plate 41a is located in the +X direction and a support plate 41b is located in the -X direction. Between the pair of support plates 41a and 41b, a guide shaft section 42 is provided extending in the X-axis direction to support the carriage 5 and to guide the carriage 5 along the X-axis direction. Guide shaft engagement holes 43 (see FIG. 3) are formed in the pair of support plates 41a and 41b at positions corresponding to each other, and an end of the guide shaft section 42 on the +X direction is inserted into the guide shaft engagement hole 43 of the support plate 41a in a fixed state. The end of the guide shaft section 42 on the -X direction side is inserted into the guide shaft engagement hole 43 in the support plate 41b in a fixed state. In FIG. 2 and FIG. 3, a shaft center C1 of the guide shaft section 42 is indicated by a dashed and dotted line. A through hole 511 that penetrates in the X-axis direction is provided in the carriage 5 and the guide shaft section 42 is inserted in the through hole 511 along the X-axis direction.

The guide shaft section 42 functions as a support part to support the carriage 5, which can move from a non-cutting position where the blade 61 of the cutter unit 6 which is the cutting section, does not cut the cut medium S to a cutting position where the blade 61 of the cutter unit 6 can cut the cut medium S. Here, a "non-cutting position" includes a "separated position" where the blade 61 is in a state completely separated from the sheet surface S1 of the cut medium S, and a "contact position (state in which a blade edge lightly contacts the paper before cutting)" where the blade 61 is in a state in which the blade 61 is in contact with the sheet surface S1 of the cut medium S but has not started cutting. In a case in which the cutting apparatus 100 is configured to enable full cutting, which cuts the entire thickness direction of the cut medium S, and half cutting, which cuts in a state leaving a portion of the thickness direction of the cut medium S uncut, the "cutting position" includes a "full cutting position" and a "half cutting position". A "blade edge adjustment work (preparatory work to lightly contact the blade edge to adjust an orientation of the blade in the contact position)" described below is performed with the blade 61 positioned in the "contact position" among the "non-cutting positions".

In addition, support shaft engagement holes 47 are formed in the pair of support plates 41a and 41b at corresponding positions on the -Z direction side of the guide shaft engagement holes 43. A support shaft 48a on the +X direction side is inserted in the support shaft engagement hole 47 of the support plate 41a in a fixed state. A support shaft 48b on the -X direction side is inserted in the support shaft engagement hole 47 of the support plate 41b in a fixed state. In FIG. 2 and FIG. 3, a hypothetical shaft center C2 of the support shaft 48 (support shafts 48a, 48b) is indicated by a double dotted and dashed line. The shaft center C1 of the guide shaft section 42 and the shaft center C2 of the support shaft 48 match each other in the positions in the Y-axis direction and are offset vertically in the positions in the Z-axis direction. Both support shafts 48a and 48b project from the support shaft engagement holes 47 along the X-axis direction, and the projecting portions of the support shafts 48a and 48b include cylindrical shaped outer peripheral surfaces.

The side plate 11a and side plate 11b of the apparatus main body 1 are each provided with a shaft hole not shown in the drawing. The shaft holes are formed so that their centers are coaxially located with the virtual shaft centers C2 of the support shafts 48a and 48b, and a bearing member 12 (see FIG. 2) is attached to each shaft hole. The bearing member 12 includes, for example, a ring-shaped bearing. The projecting portions of the support shafts 48a and 48b are inserted into the shaft holes of the side plates 11a and 11b, respectively, via this bearing member 12 and are rotatably supported around the shaft center C2. In other words, the support shafts 48a and 48b, arranged one on each side of the X-axis direction, are rotatably supported around the shaft center C2 extending in the X-axis direction toward the side panels 11a and 11b of the apparatus main body 1. The support shafts 48a and 48b are positioned closer to the cut medium S than the guide shaft section 42 in the Z-axis direction (on the -Z direction side of the guide shaft section 42).

As shown in FIG. 1, etc., the carriage movement mechanism 40 includes a driving belt 44 provided parallel to the guide shaft section 42 and a belt drive motor 45 that operates the driving belt 44. The driving belt 44 is an endless belt that is passed over pulleys 46 supported on both end sides (side plates 11a and 11b) of the apparatus main body 1 in the X-axis direction, and has a loop structure with the driving belt 44 swiveling between the pulleys 46, 46. When the pulley 46 is rotated by the drive of the belt drive motor 45, the driving belt 44 moves in the X-axis direction. The carriage 5 is provided with a belt connection 54 to which the driving belt 44 is connected. When the driving belt 44 moves in the X-axis direction, its force is transmitted to the belt connection 54, causing the carriage 5 to move along the X-axis direction. By controlling the belt drive motor 45 and switching a rotation direction of the pulleys 46, a movement direction of the carriage 5 in the X-axis direction can be switched in the +X or -X direction as appropriate.

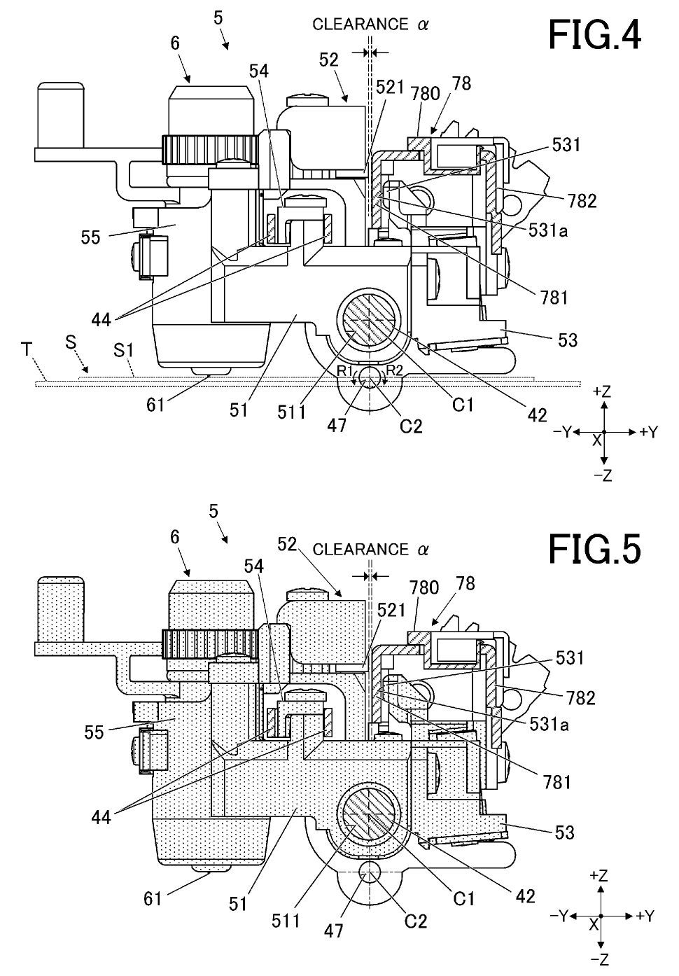

The carriage 5, which is moved by the carriage moving mechanism 40, includes a main body section 51 including a through hole 511 through which the guide shaft section 42 is inserted, and a first transmission section 52 and a second transmission section 53 which are fixed to the main body section 51. The first transmission section 52 is located on the +Z direction side in the main body section 51, and the second transmission section 53 is located on the +Y direction side in the main body section 51. A bearing 521 is provided in the first transmission section 52. The bearing 521 includes a substantially cylindrical shaped outer peripheral surface and is supported to freely rotate around a support axis, not shown, which is an axis substantially perpendicular to the X-axis direction (roughly matching to the Z-axis direction). The surface on the +Y direction side of the first transmission section 52 faces the surface on the -Y direction side of a front plate section 781 of a pressing member 78, which will be described later. The bearing 521 is positioned so that it is exposed to the surface on the +Y direction side of the first transmission section 52. According to the present embodiment, the first transmission section 52 including the bearing 521 is a pressed section that is pressed by the front plate section 781 of the pressing member 78, which is the pressing section. As shown in FIG. 4 to FIG. 7, a clearance α (in this embodiment, a dimension of the clearance α between the bearing 521 and the front plate section 781 is 0.4 ± 0.1 mm) exists between the bearing 521 and the front plate section 781 as a buffer function part. When the pressing member 78 is subjected to an elastic load by an elastic body (torsion spring 74) described below, the surface on the -Y direction side of the front plate section 781 of the pressing member 78 contacts the bearing 521 and this clearance α becomes zero (see FIG. 8).

The second transmission section 53 includes a projecting portion 531 that projects to the +Z direction side. The projecting portion 531 enters the inside of the pressing member 78, which is approximately U-shaped in cross section. A contact surface 531a, which is the surface on the -Y direction side of the projecting portion 531, can face and contact the surface on the +Y direction side of the front plate section 781 of the pressing member 78. The bearing 521 and the contact surface 531a are each in contact with the front plate section 781, movable relative to the X-axis direction. When the pressing member 78 rotates about the shaft center C2 as described below, force is transmitted from the front plate section 781 to the bearing 521 and the contact surface 531a, and the carriage 5 rotates about the shaft center C2 together with the pressing member 78. More specifically, when the bearing 521 is pressed by the front plate section 781 of the pressing member 78, the carriage 5 rotates in a first rotation direction R1 (see FIG. 4). When the projecting portion 531 (contact surface 531a) of the second transmission section 53 is pressed by the front plate section 781 of the pressing member 78 and the carriage 5 rotates in a second rotation direction R2 (see FIG. 4), the carriage 5 is raised up (state in the "separated position", hereinafter also referred to as the "separated state"). When the carriage 5 is in the "separated state" (holding state) where the carriage 5 is raised up, it is configured so that the projecting portion 531 and the front plate section 781 are in contact with each other. This also functions as a limiter to prevent the carriage 5 from going up too high when it is raised.

A unit holding section 55 is provided on the -Y direction side of the main body section 51 of the carriage 5. The unit holding section 55 is a holder portion that removably holds the cutter unit 6, which is the cutting section equipped with the blade 61. According to the present embodiment, in a state in which the cutter unit 6 is held in the unit holding section 55, the blade edge of the blade 61 projects from the end on the -Z direction side of the cutter unit 6 by a predetermined amount. A tip portion (blade edge) of the blade 61 has a slanted shape, and when the cut medium S is cut, the blade 61 faces in the direction to be cut. In order to freely orient the blade 61 in the desired direction, the blade 61 is, for example, freely rotatable around a blade axis along approximately the Z-axis direction in the cutter unit 6, and is held as load-free as possible. Before starting the cutting operation, the "blade edge adjustment work" is performed to adjust the orientation of the blade 61 by bringing the blade edge into contact with the sheet surface S1, etc. of the cut medium S.

The cutting apparatus 100 is also provided with a pressing mechanism 70 (see FIG. 2) including a pressing member 78, a torsion spring 74, and the like. The pressing member 78 includes a front plate section 781, which is a pressing section. The torsion spring 74 is an elastic body that applies an elastic load to the pressing member 78. According to the present embodiment, the pressing member 78 is a substantial U-shaped member in cross section including an upper plate section 780, the front plate section 781, and a rear plate section 782, each of which is a flat-shaped wall portion. The front plate section 781 is extended downward from the -Y direction side edge of the upper plate section 780, and the rear plate section 782 is extended downward from the +Y direction side edge of the upper plate section 780. The torsion spring 74 is an elastic body for applying an elastic load. The composition of the elastic body is not limited to those illustrated here. The pressing mechanism 70 includes an elevation drive motor 71 as a drive means for operating the pressing member 78 to change the height position of the blade 61 of the cutter unit 6 relative to the sheet surface S1 of the cut medium S. The elevation drive motor 71 is, for example, a pulse motor. A controller, not shown in the figure, controls the number of drive pulse signals fed into the elevation drive motor 71 to precisely control a rotation angle of the pressing member 78.

The specific configuration of the pressing mechanism 70 is as follows. That is, the elevation drive motor 71 is mounted on the side of the side plate 11 (side plate 11b in FIG. 1), for example. The output shaft of the elevation drive motor 71 is provided with a pinion 71a, and the pinion 71a is engaged with a first gear 72. A transmission section 73a of a second gear 73 is supported on an inner side of the first gear 72. One end and the other end of the torsion spring 74 are engaged with a spring-hanging section 72a provided inside the first gear 72 and a spring-hanging section 73b provided in the transmission section 73a of the second gear 73. By driving the elevation drive motor 71, the amount of deflection of the torsion spring 74 increases as the first gear 72 rotates, and when the torsion spring 74 reaches a predetermined amount of deflection, the rotation is transmitted from the first gear 72 to the second gear 73 via the torsion spring 74. In other words, with the rotation transmitted from the first gear 72 to the second gear 73, a spring force of the torsion spring 74 is charged.

The second gear 73 meshes with a fan-shaped first sector gear 75. The first sector gear 75 is provided with a fan-shaped second sector gear 76 that rotates coaxially and integrally with the first sector gear 75. The second sector gear 76 meshes with a fan-shaped third sector gear 77 fixed to the support plate 41 (in FIG. 3, support plate 41b). The rotation of the second gear 73 is transmitted to the first sector gear 75, and the second sector gear 76 rotates with the first sector gear 75. Furthermore, the rotation of this second sector gear 76 is transmitted to the third sector gear 77. When the third sector gear 77 rotates, the guide shaft section 42, the pressing member 78, and the support plates 41a, 41b rotate in unison about the shaft center C2. The third sector gear 77 is configured with a smaller number of gears and has a fixed upper and lower limit of rotation. This constrains the movement so that the third sector gear 77 does not rotate more than necessary (i.e., the carriage 5 is not raised too high).

Thus, according to the present embodiment, the pressing mechanism 70 includes an elevation drive motor 71, a first gear 72, a second gear 73, a torsion spring 74, a first sector gear 75, a second sector gear 76, a third sector gear 77, and a pressing member 78. Since the controller controls the elevation drive motor 71 to switch the rotation direction of the pinion 71a, the rotation direction of the guide shaft section 42, the pressing member 78, and the support plates 41a and 41b around the shaft center C2 can be switched between the first rotation direction R1 and the second rotation direction R2 shown in FIG. 4, etc. The first gear 72, second gear 73, first sector gear 75, and second sector gear 76 are each supported by the side plate 11b and supported to be rotatable around a gear axis extending in the X-axis direction.

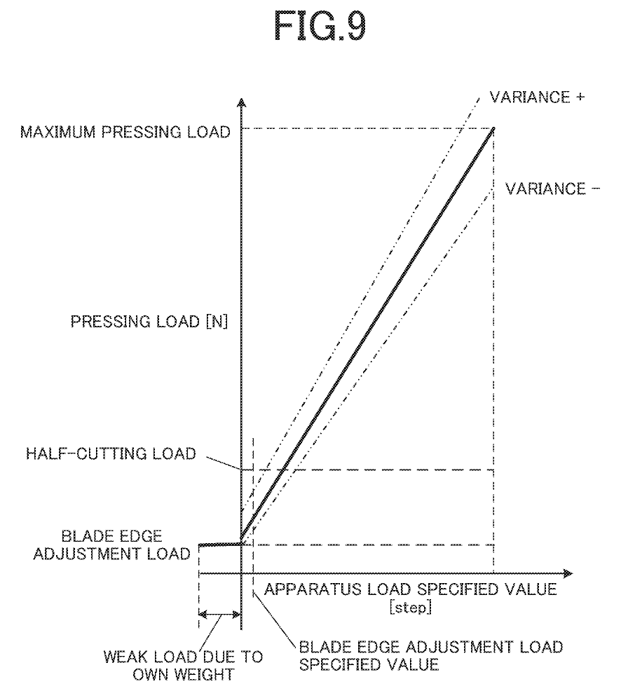

The pressing mechanism 70 can adjust a processing section pressing load at which the processing section of the carriage 5 (i.e., the cutter unit 6, which is the cutting section) presses the cut medium S by changing a pressing section pressing load at which the front plate section 781, which is the pressing section, presses against the pressed section (the first transmission section 52 including the bearing 521) toward the cut medium S side based on the elastic load applied by the torsion spring 74. This allows the carriage 5 to move between the "non-cutting position" and the "cutting position". In other words, if the rotation direction of the guide shaft section 42, the pressing member 78, and the support plates 41a, 41b around the shaft center C2 is the first rotation direction R1, the front plate section 781 presses the first transmission section 52 including the bearing 521. The "pressing section pressing load" means the load with which the front plate section 781 of this pressing mechanism 70 presses the first transmission section 52, including the bearing 521. The carriage 5 rotates (pivot) in the direction that the blade 61 of the cutter unit 6 approaches the cut medium S side, when the "pressing section pressing load" is applied. The "processing section pressing load" means the load by which the cutter unit 6 (the blade 61 of the cutter unit 6) presses the cut medium S. As shown in FIG. 9, the "processing section pressing load" is a weak load due to its own weight until the "pressing section pressing load" begins to be applied. In other words, the "processing section pressing load" is a weak pressure generated according to the laws of nature by the weight of the pressing mechanism itself without any external force. In contrast, when the "pressing section pressing load" which is a main body load originating from the pressing mechanism 70, is applied, the "processing section pressing load" is approximately equal to the "pressing section pressing load".

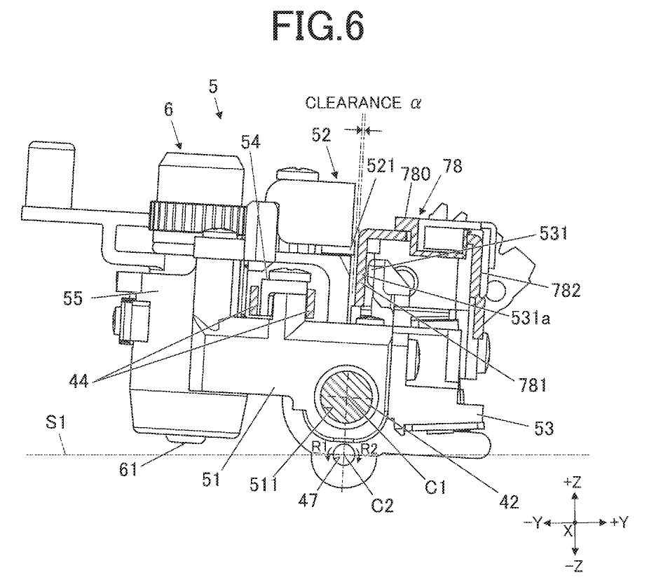

On the contrary, if the rotation direction of the guide shaft section 42, the pressing member 78, and the support plates 41a, 41b around the shaft center C2 is the second rotation direction R2, the carriage 5 is pushed up by the front plate section 781 pressing the projecting portion 531 of the second transmission section 53, and the carriage 5 can be rotated (pivoted) in the direction in which the blade 61 of the cutter unit 6 is separated from the cut medium S side. This leaves the carriage 5 in the "non-cutting position", that is, the "separated position" as shown in FIG. 6. As mentioned above, when the carriage 5 is in the "separated state" (holding state) when it is raised up, the projecting portion 531 and the front plate section 781 hitting each other functions as a limiter to prevent the carriage 5 from rising too high when it is raised up. The pressing load of the blade 61 of the cutter unit 6 against the cut medium S (processing section pressing load) is set according to the force (elastic load) of the torsion spring 74 provided between the first gear 72 and the second gear 73, and as shown in FIG. 9, the higher an apparatus load specified value (the number of drive pulse signals (step) input to the elevation drive motor 71) is set, the higher the "pressing section pressing load" and the pressing load of the blade 61 against the cutting medium S (processing section pressing load) that the pressing mechanism 70 presses the first transmission section 52 including the bearing 521 become.

The cutting apparatus 100 is provided with a buffer function section that suppresses the "pressing section pressing load" on the bearing 521 by the front plate section 781, which is the pressing section of the pressing mechanism 7, until the "processing section pressing load" exceeds a predetermined load. As mentioned above, according to the present embodiment, a clearance α is formed between the front plate section 781, which is the pressing section, and the bearing 521 of the second transmission section 53, which is the pressed section pressed by the front plate section 781, as the buffer function section (see FIG. 4, etc.). Here, "the 'processing section pressing load' exceeds the predetermined load" means that the load exceeds the load suitable for performing "blade edge adjustment work" ("blade edge adjustment load" shown in FIG. 8), in which the blade edge of the blade 61 of the cutter unit 6 which is the cutting section, is pressed against the cut medium S but does not result in cutting. As shown in FIG. 9, the cutting apparatus 100 can cut the cut medium S by the blade edge 61 when the blade edge adjustment load specified value is exceeded and a half-cutting load, etc. begins to be applied. The clearance α is held to the extent that the "processing section pressing load" exceeds the "blade edge adjustment load specified value" shown in FIG. 9, and is configured to suppress the "pressure section pressing load", which is the main body load originating from the pressing mechanism 70. In other words, the buffer function section acts as a function to generate loads stepwise during the time until the load due to the weight of the pressing mechanism 7 itself is directly transmitted to the sheet surface S1 of the cut medium S. By suppressing the pressing force derived from the load of the pressing mechanism 7 in an initial load step by the pressing mechanism 7, it is possible to transmit the weak pressing force (weak load) necessary for the blade edge adjustment work to the sheet surface S1, etc. Before the front plate section 781 which is the pressing section contacts the bearing 521 which is the pressed section and the pressing force of the pressing mechanism 7 is applied according to the elastic load by the torsion spring 74 which is the elastic body, the blade edge of the blade 61 of the cutter unit 6 which is the cutting section is subjected to the load due to the weight of the carriage 5 in the cutting direction (-Z direction), which is the direction in which the blade 61 heads toward (approaches) the cut medium S side. In this case, the range that constitutes the self-weight of the carriage 5 is the portion shown in light color in FIG. 5. In addition to the above, the driving belt 44, shown as a cross section, may also be related to its own weight since it is engaged to the carriage 5. The dimension of the clearance α is not limited to the dimension described in the above embodiment, but can be any dimension necessary to ensure the "blade edge adjustment load" on the sheet surface S1 of the cut medium S when the pressing mechanism 7 transmits the load to the bearing 521, which is the pressed section.

In other words, when looking at the balance of the carriage 5 in the Y-axis direction around the guide shaft section 42, the -Y direction side of the carriage 5, where the cutter unit 6, etc. is provided, is heavier than the +Y direction side. Therefore, the load due to the weight of the carriage 5 itself is applied to the -Y direction side of the carriage 5, and the carriage 5 lowers its -Y direction side in the cutting direction (-Z direction) with the shaft center C1 of the guide shaft section 42 as the rotation center. The load applied in the cutting direction (-Z direction) by its own weight is a weak load that is weaker than the pressing load required for the blade edge of the blade 61 of the cutter unit 6 to cut the cut medium S. In this state in which the weak load is applied, the blade edge of the blade 61 is placed in the "contact position" where it contacts the sheet surface S1 of the cut medium S but does not cut it. According to the present embodiment, the "blade edge adjustment work" is performed to adjust the orientation of the blade 61 in this state. Specifically, the carriage 5 or the cut medium S is moved in the XY horizontal plane with the blade 61 positioned in the "contact position". At this time, the blade edge of the blade 61 follows this movement with a delay. This allows the orientation of the blade edge to be determined ("blade edge adjustment work"). At the moment the cutting apparatus 100 is started, it is not possible for the apparatus to know the orientation of the blade 61. Here, the "blade edge adjustment work" allows the blade 61 to cut forward in the proper direction when the operation advances to the cutting operation to cut the cut medium S. In FIG. 9, the pressing load (weak load) that is sufficient to position the blade edge of the blade 61 at the "contact position" where it contacts but does not cut the sheet surface S1 of the cut medium S is shown as the "blade edge adjustment load”. The "pressing section pressure load" shown in FIG. 9 is due to the mechanical structural characteristics of the pressing mechanism 70, and the "half-cutting load" is due to the correspondence between the cutting performance of the pressing mechanism 70 and material characteristics of the target to be cut. The "blade edge adjustment load" and "blade edge adjustment load specified value" can be changed as needed according to the structure of the pressing mechanism 70 (center of gravity position, weight, elastic properties of the torsion spring 74, etc.), performance (cutting capability, own weight balance of the carriage 5, etc.), and material properties (material, thickness, surface condition, etc.) of the cut medium.

Although not shown in the figure, the cutting apparatus 100 includes a controller. The controller includes a processor, such as a central processing unit (CPU), and a storage. The processor reads the program stored in the storage and executes it to control the operation of each part of the cutting apparatus 100. The cutting apparatus 100 includes a medium position detection sensor on a lower surface, or the like of the carriage 5. The medium position detection sensor optically detects positioning marks (printing marks) on the backing paper T or the processed medium S. The cutting apparatus 100 also includes an X direction position detector that detects the position of the carriage 5 in the X-axis direction and a rotational position detector that detects a rotational position of the carriage 5 and the pressing member 78 about the shaft center C2 (both of the above are not shown). The detection signal output by the medium position detection sensor, the X direction position detector, the rotational position detector, etc. are input to the controller as necessary. The controller controls the operation of each part of the apparatus, at least the conveyance drive motor 22, belt drive motor 45, and elevation drive motor 71, according to these detection signals.

Next, the operation of the cutting apparatus 100 in the above configuration will be described. When setting the cut medium S in the cutting apparatus 100, the controller controls the elevation drive motor 71 to position the pressing member 78 and the carriage 5 in the "separated position" (the position where the blade 61 is completely separated from the sheet surface S1 of the cut medium S) of the "non-cutting position". In this state, when the cut medium S is inserted between the conveyance rollers 21, 21, an intrusion detection sensor (not shown) detects the intrusion of the cut medium S, and the conveyance rollers 21, 21 start rotating. As a result, the cut medium S is held between the conveyance rollers 21, 21 and can be conveyed along the Y-axis direction.

The controller drives the conveyance drive motor 22 to feed the cut medium S in the Y-axis direction and drives the belt drive motor 45 to adjust the position of the carriage 5 in the X-axis direction, causing the positioning mark on the cut medium S to be detected by the position detection sensor. Once the positioning mark is detected, the cut medium S is positioned in the cuttable range below the carriage 5 based on the positioning mark. Before moving the carriage 5 to a predetermined position (such as a cuttable range) or preparing for cutting such as "blade edge adjustment work", the controller drives the elevation drive motor 71 to operate the pressing mechanism 7. This causes the carriage 5 to be raised in the direction that the blade 61 separates from the cut medium S resulting in the state in the "separated position" (this is also referred to as the "blade separated state" or "first state" in the present embodiment) as shown in FIG. 6. In this "blade separated state" ("first state"), the pressing member 78 of the pressing mechanism 7 is separated from the carriage 5, and the clearance α exists between the pressing member 78, which is the pressing section, and the bearing 521, which is the pressed section. The force from the driving belt 44 engaged to the carriage 5 (belt tension by the driving belt 44) acts on the carriage 5 and the pressing member 78 of the pressing mechanism 7. In other words, the driving belt 44 is provided over the X-axis direction of the apparatus and is engaged on both the left and right sides of the X-axis direction. Therefore, when the pressing mechanism 7 operates and the carriage 5 and the pressing mechanism 7 tilt to the right side in FIG. 6, for example, the driving belt 44 is also pressed and pulled to the right side in FIG. 6 (state in which belt is tensioned). The driving force of the elevation drive motor 71 that operates the pressing mechanism 7 is stronger than a restoring force (reaction force) that tries to restore the driving belt 44 to the original state from the tensioned state or the force that tries to make the carriage 5 fall due to its own weight. In other words, when the carriage 5 is raised upward (state in the "separated position", "blade separated state" ("first state")), the force due to the rotation of the pressing mechanism 70 in the R2 direction around the support shaft 48 is large. Therefore, the carriage 5 is held in this posture with the front plate section 781 in contact with the projecting portion 531.

When an instruction to start cutting is given, the controller drives the elevation drive motor 71 of the pressing mechanism 7 in the direction of pushing the carriage 5 in the -Y direction (-Z direction) to gradually tilt the pressing member 78. This causes the front plate section 781 to separate from the projecting portion 531, and then the force of the driving belt 44 in the -Y (-Z) direction acts on the carriage 5. Furthermore, during this time, the force in the -Z direction due to the weight of the carriage 5 itself also acts, and this causes the entire carriage 5 to rotate in the R1 direction around the shaft center C2. Triggered by the force of the pressing mechanism 7 (pressing force by the elevation drive motor 71), the entire carriage 5 also rotates around the shaft center C2, and the driving belt 44 is released as the carriage 5 approaches a horizontal state, and the restoring force (reaction force) gradually becomes weaker. The pressing member 78 is tilted, and when the carriage 5 becomes the almost horizontal state as a result, the restoring force due to the belt tension of the driving belt 44 becomes 0. When the restoring force (reaction force) of the driving belt 44 is no longer applied, the carriage 5 tilts due to its own weight to the heavier side (in the embodiment, the side in the -Y direction where the cutter unit 6 is provided) in a case in which a front-back balance in the Y-axis direction around the guide shaft section 42 is viewed. This causes the carriage 5 to rotate (swing) in a direction where the cutter unit 6 side is lowered in the -Z direction around the shaft center C1 of the guide shaft section 42. In this state, no active pressure load in the cutting direction (-Z direction) is applied by the pressing mechanism 70. In other words, when the force due to its own weight is greater than the restoring force of the driving belt 44, the carriage 5 brings the blade 61 into contact with the cut medium S with only the weak load due to its own weight (this is also called the "contact state" or "second state" in the present embodiment).

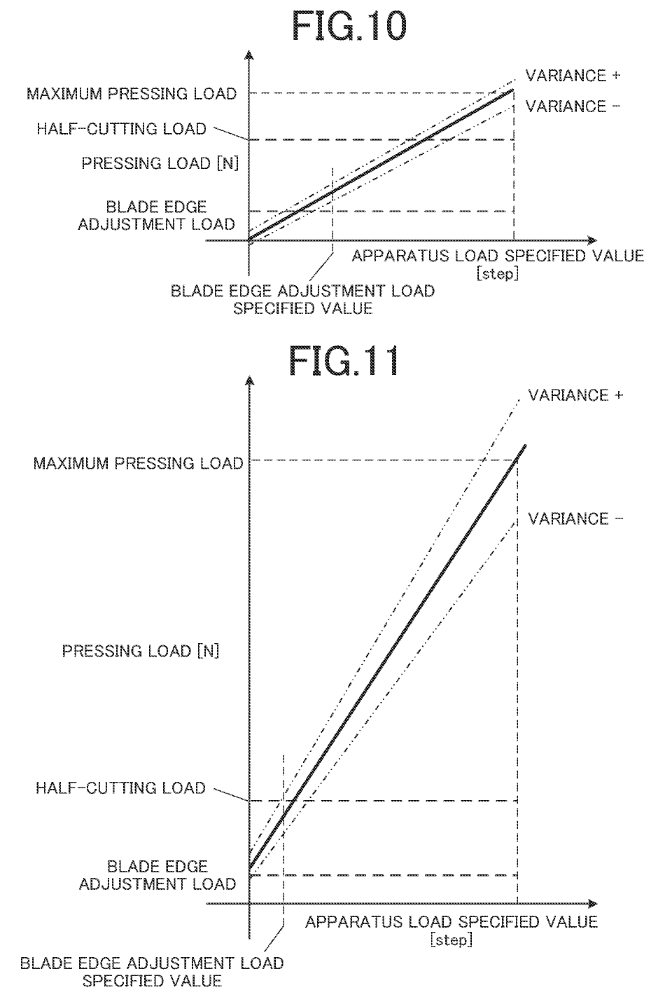

According to the present embodiment, the torsion spring 74 comprising the pressing mechanism 70 is a spring that applies a relatively strong elastic load, and when the elevation drive motor 71 is driven and the elastic load based on the torsion spring 74 begins to be applied to the bearing 521 of the first transmission section 52, which is the pressed section to be pressed via the pressing member 78, as shown in FIG. 9, the pressing load (pressing load that presses the blade 61 against the cut medium 61) based on the pressing force applied to the carriage via the bearing 521 of the first transmission section 52, which is the pressed section, increases rapidly. In other words, as shown in FIG. 10, in a case in which the pressing load is applied by the weak spring, the pressing load increases gradually with respect to the apparatus load setting value, and there is little variation due to the spring. Therefore, a distinction is realized between the load required to cut the entire cut medium S, the load required to half-cut the cut medium S (the "half-cutting load" in FIG. 10), and the load that does not even reach half-cut and that contacts the cut medium S but does not damage the sheet surface S1 (the "blade edge adjustment load" in FIG. 10). For example, if the blade edge adjustment load is set as the apparatus load setting value, a pressing load can be applied at a level that does not reach the half-cutting load required for half-cutting, even taking into account the variation caused by the spring. On the other hand, as shown in FIG. 11, in a case in which the pressing load is applied by the strong spring, the pressing load increases drastically with respect to the apparatus load setting value, and the variation due to the spring becomes large. Therefore, for example, even if a "blade edge adjustment load" is set as the apparatus load setting value and only a "blade edge adjustment load" is applied, a "half-cutting load" or the pressing load equal to or higher than the “half-cutting load” may actually be applied. As a result, the blade 61 may damage the sheet surface S1 during the blade edge adjustment work.

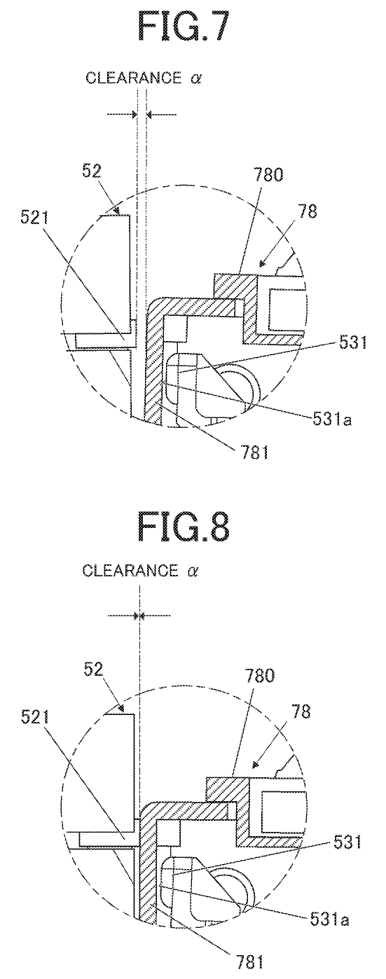

In this regard, according to the present embodiment, as shown in FIG. 7, the clearance α is provided between the bearing 521 of the first transmission section 52 and the front plate section 781 of the pressing member 78 to serve as a buffer (buffer means) to make time until the front plate section 781 of the pressing member 78 contacts the bearing 521 and starts pressing it. This clearance α suppresses the "pressing section pressing load" on the bearing 521 by the front plate section 781 until the "processing section pressure load" with which the blade 61 presses the cut medium S exceeds a predetermined load (the "blade edge adjustment load specified value" shown in FIG. 9). In other words, a preceding weak load is applied before a strong load that leads to cutting, so that the load can be adjusted stepwise when the weak load is functionally necessary (e.g., when the user wants to perform blade edge adjustment work). Specifically, while the clearance α is present, the carriage 5 only falls in the -Z direction due to its own weight, and even if the blade edge contacts the sheet surface S1 of the cut medium S, the pressing load on the cut medium S by the blade 61 ("processing section pressing load") is much lower than the "half cutting load" as shown in FIG. 9. The load is much lower than the "half-cutting load" ("weak load due to own weight" shown in FIG. 9), and is the weak load that does not lead to cutting the cut medium S. This weak load is not affected by the torsion spring 74 (e.g., the variation shown in FIG. 9). Then, when the elevation drive motor 71 is further driven and the pressing member 78 begins to rotate around the shaft center C2 due to the elastic load based on the torsion spring 74, the clearance α gradually narrows. When the clearance α completely disappears ("clearance α = 0" in FIG. 8), the load based on the torsion spring 74 (apparatus load determined by the control over the elevation drive motor 71) is applied to the carriage 5 by the front plate section 781 of the pressing member 78 pressing the bearing 521 of the first transmission section 52. The carriage 5 supported by the guide shaft section 42, the pressing member 78 and the support plates 41a, 41b rotate (pivot) about the shaft center C2 as a unit. From this point, the pressing load ("pressing section pressing load") with which the blade edge presses on the cut medium S also increases as the apparatus load ("pressing section pressing load") further increases, and when the pressing load ("processing section pressing load") exceeds the "half-cutting load", cutting of the cut medium S by the blade 61 begins.

Thus, until the clearance α, which functions as a buffer, is filled, the blade 61 contacts the sheet surface S1 of the cut medium S, but only the weak load due to its own weight is applied, so the cut medium S can remain uncut. According to the present embodiment, the "blade edge adjustment work" is performed while the pressing load by the blade 61 on the cut medium S remains within the range of the "blade edge adjustment load" due to the weight of the carriage 5 itself. In other words, the controller drives one or both of the conveyance drive motor 22 or belt drive motor 45 to move the blade 61 on the sheet surface S1 of the cut medium S, and performs "blade edge adjustment work" to adjust the orientation of the blade 61. This completes the preparation for the cutting process of the cut medium S by the cutting apparatus 100.

The controller then drives the elevation drive motor 71 as appropriate to apply the "half-cutting load" or the load required for the full cut according to the cutting data for cutting the cut medium S, and rotates the pressing member 78 and the carriage 5 in the first rotation direction R1 to move the pressing member 78 and the carriage 5 from the "non-cutting position" to the "cutting position”. This causes the blade 61 of the cutter unit 6 to descend in the -Z direction and to be pressed against the sheet surface S1 of the cut medium S. The blade 61 cuts into the cut medium S according to the pressing load ("cutting state" or "third state"). The controller controls the operation of the conveyance drive motor 22 of the medium conveyance mechanism 20 and the belt drive motor 45 of the carriage movement mechanism 40 as appropriate according to the cutting data, and thus cutting is executed according to the cutting data. In each of the above-mentioned "separated state" ("first state"), "contact state" ("second state"), and "cutting state" ("third state"), the carriage 5 can be moved along the guide shaft section 42 in the X-axis direction by the controller controlling the operation of the belt drive motor 45 of the carriage movement mechanism 40.

As described above, the cutting apparatus 100 according to the present embodiment includes, the carriage 5 and the pressing mechanism 70. The carriage 5 includes the cutter unit 6 and the bearing 521 of the first transmission section 52. The cutter unit 6 cuts the cut medium S which is the processed medium as the processing section (cutting section). The bearing 521 of the first transmission section 52 is to be the pressed section. The torsion spring 74 includes the elastic body and the pressing section. Based on the elastic load by the elastic body, the pressing section pressing load with which the pressing section presses the pressed section toward the processed medium side is changed. With this, the torsion spring 74 which is the pressing mechanism elastic body can adjust the processing section pressing load with which the processing section of the carriage presses the processed medium. The front plate section 781 is the pressing section. Based on the elastic load by the torsion spring 74, the front plate section 781 changes the “pressing section pressing load” which presses the bearing 521 toward the cut medium S side, and the pressing mechanism 70 is able to adjust the “processing section pressing load” in which the cutter unit 6 of the carriage 5 presses the cut medium S side. The buffer function section is provided in the cutting apparatus 100 between the carriage 5 and the pressing mechanism 70. The buffer function section suppresses the “pressing section pressing load” until the “processing section pressing load” exceeds the predetermined load. As a result, the clearance α is maintained until the load leading to cutting (the load exceeding the blade edge adjustment load specified value) is reached even if the cutter unit 6 (blade 61 of cutter unit 6) contacts the cut medium S. This allows the "processing section pressing load" to be in a state where the "processing section pressing load" maintains the weak load, i.e., the blade 61 is in contact with the cut medium S but does not cut it, through a simple configuration, and this state can be used to perform "blade edge adjustment work" without damaging the cut medium S.

The buffer function section according to the present embodiment is the clearance α provided between the front plate section 781, which is the pressing section, and the bearing 521 of the first transmission section 52, which is the pressed section. The clearance α is configured so that the clearance α is maintained until the front plate section 781 contacts the bearing 521 and the pressing force of the pressing mechanism 70 according to the elastic load by the torsion spring 74, which is the elastic body (the main body apparatus load) is applied. Thus, according to the above-described embodiment, before the front plate section 781, which is the pressing section, contacts the bearing 521 of the first transmission section 52, which is the pressed section, and the pressing force of the pressing mechanism 70 according to the elastic load by the torsion spring 74, which is the elastic body, is applied, the blade edge of the blade 61 of the cutter unit 6, which is the cutter section, is subjected to the load due to the weight of the carriage 5 itself in the cutting direction (-Z direction) which is the direction in which the blade 61 of the cutter unit 6 heads toward the cut medium S side. This allows the carriage 5 to be only subjected to the weak load by its own weight while the clearance α is secured. With this, it is possible to perform the "blade edge adjustment work" without the blade edge of the blade 61 damaging the cut medium S.

According to the present embodiment, the load applied in the cutting direction by its own weight is the weak load that is weaker than the pressing load required for the blade edge of the cutting section to cut the cut medium. Therefore, a simple configuration using its own weight can obtain the "blade edge adjustment load" suitable for performing the "blade edge adjustment work," i.e., the load to the extent that the blade edge contacts the cut medium S but does not lead to cutting.

### <Second Embodiment>

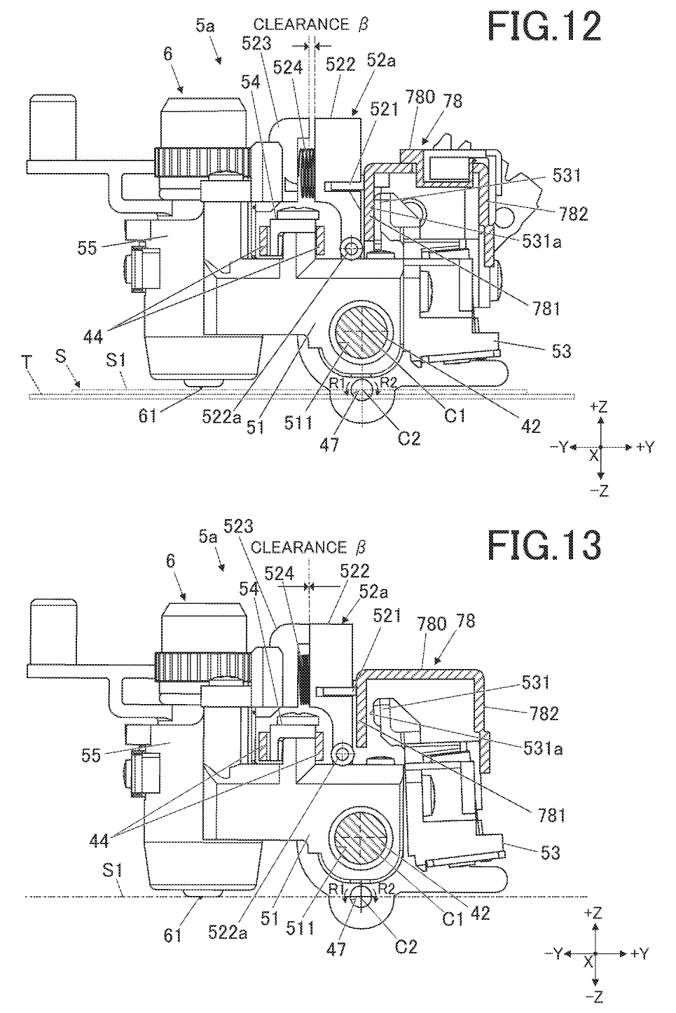

Next, with reference to FIG. 12 to FIG. 14, a second embodiment of a cutting apparatus according to the present disclosure is described. Since this embodiment differs from the first embodiment only in the configuration of the buffer function section, the points that differ from the first embodiment are explained in particular below.

This cutting apparatus according to the present embodiment includes a carriage 5a shown in FIG. 12, etc. As in the first embodiment, the carriage 5a includes a main body section 51 including a through hole 511 through which the guide shaft section 42 is inserted, a first transmission section 52a located on the +Z direction side in the main body section 51 and the second transmission section 53 fixed on the +Y direction side in the main body section 51. The first transmission section 52a according to the present embodiment includes a movable section 522 located on the +Y direction side and a fixed section 523 located on the -Y direction side than the movable section 522 and fixed to the main body section 51. The movable section 522 is connected to the main body section 51 via a connecting shaft 522a, which is an axis along the X-axis direction, and pivots around the connecting shaft 522a. The bearing 521 is provided on the surface in the movable section 522 facing the front plate section 781 of the pressing member 78, as in the first embodiment.

The first transmission section 52a (especially the movable section 522 of the first transmission section 52a) is a pressed section that is pressed by the front plate section 781 of the pressing member 78 which is the pressing section through the bearing 521. The clearance is provided between this pressed section and the cutter unit 6 including the blade 61 which is the cutting section. The clearance is provided with dimensions equivalent to those of the first embodiment. According to the present embodiment, a clearance β is formed between the movable section 522 and the fixed section 523, and a light-load spring 524 as a biasing section is provided within the clearance β. The light-load spring 524 is a light-load spring that applies a weak load to the blade 61 of the cutter unit 6 weaker than the elastic load by the torsion spring 74 which is the elastic body and holds the clearance β until the pressing load of the blade 61 of the cutter unit 6 on the cut medium S exceeds a predetermined load. According to the present embodiment, the buffer function section includes the clearance β and the light-load spring 524 that holds the clearance β. According to the present embodiment, the light-load spring 524 is provided as the biasing section, and in the example shown in FIG. 12, etc., a coil spring is assumed. However, the biasing section can be configured to have a weaker biasing force than the torsion spring 74, and is not limited to the coil spring. Moreover, the biasing section does not have to be a spring, as long as the weak biasing force can be applied.

Before the front plate section 781 of the pressing member 78 contacts the bearing 521, which is the pressed section, and the pressing force of the pressing mechanism 70 according to the elastic load by the torsion spring 74 is applied, the -Y direction side of the carriage 5a on which the cutter unit 6 is provided rotates (pivot) due to its own weight around the shaft center C1 of the guide shaft section 42 as in the first embodiment. Furthermore, a weak pressing force (elastic load) by the light-load spring 524 is applied to the fixed section 523 of the first transmission section 52a according to the present embodiment. Thus, the cut medium S, which is in contact with the blade edge of the blade 61 of the cutter unit 6, is subjected to the load due to the weight of the carriage 5a itself and the load due to the light-load spring 524 in the cutting direction (-Z direction) which is the direction in which the blade 61 heads toward the cut medium S side. Therefore, even in a case in which the bearing 521 is pressed by the front plate section 781, the clearance β is maintained until the light-load spring 524 collapses in the present embodiment, and no main body pressing load based on the torsion spring 74 is applied. Therefore, until the light-load spring 524 collapses and the clearance β becomes zero, the weak load (the weak load weaker than the "half-cutting load") is applied as the pressing load to press the blade 61 against the cut medium S, which does not result in cutting even if the blade edge of the blade 61 contacts the sheet surface S1 of the cut medium S. This state can be used to perform the "blade edge adjustment work”.

By controlling the elevation drive motor 71 of the pressing mechanism 70 to rotate the pinion 71a in the opposite direction, the carriage 5a can be rotated (pivoted) in the direction of pushing up the carriage 5a as shown in FIG. 13, and the blade 61 can be evacuated to the "separated position" separated from the sheet surface S1 of the cut medium S. In this state, the surface on the +Y direction side of the front plate section 781 of the pressing member 78 contacts the projecting portion 531 of the carriage 5a, and the projecting portion 531 is pressed, causing the entire carriage 5a to rotate in the second rotation direction R2 around the shaft center C2. The technique of rotating (pivoting) the carriage 5a in the direction of pushing it up and evacuating it to the "separated position" where the blade 61 is separated from the sheet surface S1 of the cut medium S is the same as in the first embodiment. Since the other configurations are similar to those of the first embodiment, the same reference numerals are applied to the same components and their descriptions are omitted.

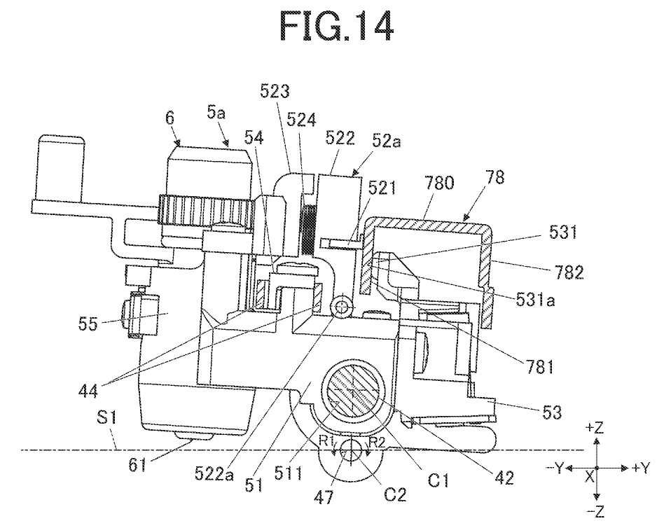

Next, the operation of the cutting apparatus in the above configuration will be described. As in the first embodiment, before moving the carriage 5a to a predetermined position (such as a cuttable range) and starting cutting preparations such as "blade edge adjustment work," the carriage 5a is in the "separated position" (the position where the blade 61 is completely separated from the sheet surface S1 of the cut medium S) as shown in FIG. 14. Since the operation in this "separated state" is the same as in the first embodiment, the explanation is omitted. When there is an instruction to start cutting, the controller drives the elevation drive motor 71 of the pressing mechanism 7 in the direction of pushing the carriage 5 in the -Y direction (-Z direction). Triggered by the force of the pressing mechanism 7 (pressing force by the elevation drive motor 71), the entire carriage 5 also rotates around the shaft center C2, and the driving belt 44 is released as the carriage 5 approaches the horizontal state, and the restoring force (reaction force) gradually becomes weaker. When the carriage 5 is almost horizontal, the restoring force due to the belt tension of the driving belt 44 becomes zero.

When the restoring force (reaction force) of the driving belt 44 is no longer applied, the carriage 5a tilts due to its own weight to the heavier side (in the embodiment, the side in the -Y direction where the cutter unit 6 is provided) in a case in which the front-back balance in the Y-axis direction around the guide shaft section 42 is viewed. In other words, the carriage 5a rotates (pivots) in the direction that the cutter unit 6 side is lowered in the -Z direction around the shaft center C1 of the guide shaft section 42. Furthermore, according to the present embodiment, the cutter unit 6 side is pressed down in the -Z direction by the light-load spring 524 located in the clearance β. This causes the blade 61 to contact the cut medium S by its own weight and the pressing force from the light-load spring 524. In this state, no active pressing load in the cutting direction (-Z direction) is applied by the pressing mechanism 70, and the "processing section pressing load" with which the blade 61 presses the cut medium S remains within the range of the "blade edge adjustment load" with which the blade 61 contacts the cut medium S but does not lead to cutting. Until the "processing section pressing load" exceeds the predetermined load (the "blade edge adjustment load specified value" shown in FIG. 9), the clearance β is maintained by the light-load spring 524 to suppress the "pressing section pressing load" on the bearing 521 by the front plate section 781. According to the present embodiment, as in the first embodiment, the "blade edge adjustment work" is performed while the pressing load by the blade 61 on the cut medium S remains within the range of the "blade edge adjustment load". Thus, when the force due to its own weight is greater than the restoring force of the driving belt 44, the carriage 5 brings the blade 61 into contact with the cut medium S only by its own weight and the pressing force by the light-load spring 524 ("contact state").

In contrast, when the "processing section pressing load" exceeds the predetermined load ("blade edge adjustment load specified value" shown in FIG. 9), the clearance β fills (clearance β = 0) against the light-load spring 524 and the "pressing section pressing load" on the bearing 521 by the front plate section 781 begins to be actively applied, as shown in FIG. 13. In other words, as the controller further drives the elevation drive motor 71, the pressing load of the blade 61 against the cut medium S ("processing section pressing load") is also increased accordingly, and when the "processing section pressing load" reaches the "half-cutting load" or the load required for the full cut, the pressing member 78 and the carriage 5 move from the "non-cutting position" to the "cutting position". In other words, as shown in FIG. 13, the blade 61 cuts into the sheet surface S1 of the cut medium S and it becomes a state in which cutting is possible ("cutting state"). Other operations are the same as in the first embodiment and therefore the description is omitted.

As described above, according to the present embodiment, the same effects as the first embodiment, as well as the following effects can be achieved. In other words, according to the present embodiment, the buffer function section includes the clearance β between the first transmission section 52a (especially the movable section 522 of the first transmission section 52a), which is the pressed section, and the blade 61 of the cutter unit 6, which is the cutting section, and a light-load spring 524 in the clearance β. The light-load spring 524 is a biasing section that applies a weaker weak load to the blade 61 of the cutter unit 6 than the elastic load by the elastic torsion spring 74 which is the elastic body and holds the clearance β until the load of the blade 61 on the cut medium S exceeds a predetermined load ("blade edge adjustment load specified value" shown in FIG. 9).

In other words, according to the present embodiment, before the front plate section 781 of the pressing member 78, which is the pressing section, contacts the first transmission section 52a (especially the movable section 522 of the first transmission section 52a) and the main body pressing force of the pressing mechanism 70 according to the elastic load by the torsion spring 74 is applied, the cut medium S in which the blade edge of the blade 61 of the cutter unit 6 comes into contact is subjected to the load due to the weight of the carriage 5 itself and the load due to the light-load spring 524 in the cutting direction (-Z direction), which is the direction in which the blade 61 heads toward the cut medium S side. According to the above, even if, for example, the weight of the carriage 5 on the -Y direction side where the cutter unit 6 is provided is not enough as the weight (too light, etc.) to provide the "blade edge adjustment load", the load can be easily adjusted to the required load by adding the elastic load of the light-load spring 524. In other words, according to the configuration of the present embodiment, any load can be set by the light-load spring 524 to be added, without relying on the weight of the component itself determined by the equipment design.

Various embodiments of the present disclosure are described above but the present disclosure is not limited to the above embodiments, and various modifications are possible without leaving the scope of the present disclosure. For example, according to the above embodiment, the carriage 5 provided with the cutter unit 6 moves in the X-axis direction and the cut medium S is conveyed in the Y-axis direction. However, the cutting unit and the cut medium S need only move relatively in the X-axis and Y-axis directions, and the way of movement is not limited to that shown above. For example, the cutting section may move in the X-axis and Y-axis directions, while the cut medium S is fixed. Alternatively, the cutting section may be fixed and the cut medium S may be configured to move in the X-axis and Y-axis directions.

The pressing mechanism 70 presses the pressed section of the carriage 5, and the mechanism need only be capable of adjusting the "processing section pressing load" by which the processing section of the carriage 5 presses the processed medium by changing the "pressing section pressing load" that presses the pressed section of the carriage 5 toward the processed medium side, and the configuration is not limited to the configuration shown in the present embodiment. For example, the pressure mechanism may include a cylinder mechanism using hydraulic pressure, etc., an electric actuator, a cam mechanism, etc.

According to the present embodiment, the case in which the processing apparatus is the cutting apparatus and the cutting section (cutter unit 6) including the blade 61 is provided as the processing section is illustrated, but the processing apparatus is not limited to the cutting apparatus. The configuration shown in the embodiment can be widely applied to any device that performs some kind of processing on the processed medium. In this case, the carriage is equipped with various processing sections used for processing as necessary.

According to the present embodiment, the case in which the elastic body provided in the pressing mechanism is the torsion spring 74 is illustrated, but the elastic body is not limited to a torsion spring as long as it can generate a load to press the pressed section. For example, compression springs, tension springs, plate springs, etc. are widely applicable as elastic bodies. Specifically, the elastic body can be a rubber torsion spring, for example, and this is a mechanism that uses the elasticity of rubber to absorb and repel torsional forces. In this case, the properties of rubber are utilized to provide excellent vibration absorption and shock mitigation. The elastic body can also be a torsion bar, for example, and this is a mechanism that stores elastic energy by twisting a metal bar and uses the force to return it to its original position. The elastic body may also be an elastic joint, and this is a mechanism that uses rubber or other elastic material to absorb and transmit rotational motion. Other elastic materials are not limited to those illustrated here.

According to the present embodiment, the carriage 5 rotates (pivots) due to its own weight around the shaft center C1 of the guide shaft section 42, and in a case in which the support plates 41a, 41b and the guide shaft section 42 and the pressing member 78, etc., which are engaged thereto, rotate (pivot) collectively by the operation of the pressing mechanism 70, the carriage 5 rotates (pivots) around the shaft center C2 of the support shafts 48a, 48b set in the -Z direction than the shaft center C1 of the guide shaft section 42. However, the carriage 5 may be configured to rotate around the same axis (e.g., the shaft center C1 of the guide shaft section 42) when the carriage 5 rotates due to its own weight or when the carriage 5 rotates by the operation of the pressing mechanism 70.

Other specific details such as arrangement of the configuration, order and numerical values in the processes, and the like shown in the above embodiments can be changed as needed without departing from the scope of this disclosure. The scope of this disclosure is not limited to the embodiments described above, but includes the scope of the invention described in the claims and their equivalents.

What is claimed is:

1. A medium processing apparatus comprising:
a carriage including a processing section that processes a processed medium and a pressed section; and
a pressing mechanism including an elastic body and a pressing section, wherein, the pressing mechanism is configured to be capable of adjusting a processing section pressing load at which the processing section of the carriage presses the processed medium by varying a pressing section pressing load at which the pressing section presses the pressed section toward the processed medium side based on an elastic load by the elastic body,
wherein a buffer is provided between the carriage and the pressing mechanism, wherein the buffer suppresses the pressing section pressing load until the processing section pressing load exceeds a predetermined load.

2. The medium processing apparatus according to claim 1, wherein,
a clearance is formed between the pressing section and the pressed section as the buffer, and
the clearance is configured to be maintained until the pressing section contacts the pressed section and a pressing force is applied by the pressing mechanism in accordance with the elastic load by the elastic body.

3. The medium processing apparatus according to claim 2, wherein, before the pressing section contacts the pressed section and the pressing mechanism applies a pressing force according to the elastic load by the elastic body, the processing section is subjected to a load due to an own weight of the carriage itself in a processing direction which is a direction in which the processing section heads toward the processed medium side.

4. The medium processing apparatus according to claim 3, wherein the load applied in the processing direction by the own weight is a weak load that is weaker than the pressing load required for the processing section to process the processed medium.

5. The medium processing apparatus according to claim 1, wherein the buffer includes,
a clearance provided between the pressed section and the processing section, and
a biasing section provided in the clearance,
wherein,
the biasing section applies a weak load that is weaker than the elastic load by the elastic body to the processing section, and
the biasing section holds the clearance until the processing section pressing load against the processed medium by the processing section exceeds the predetermined load.

6. The medium processing apparatus according to claim 5, wherein, before the pressing section contacts the pressed section and the pressing mechanism applies a pressing force according to the elastic load by the elastic body, the processed medium to which the processing section contacts is subjected to a load due to an own weight of the carriage itself and a load due to the biasing section in a processing direction which is a direction in which the processing section heads toward the processed medium side.
